(19) United States
(12) Patent Application Publication
(10) Pub. No.: US 2006/0242138 A1
(43) Pub. Date: Oct. 26, 2006

(54) Page-biased search

(75) Inventors: Eric D. Brill, Redmond, WA (US); Robert J. Ragno, Kirkland, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 11/210,652

(22) Filed: Aug. 24, 2005

Related U.S. Application Data
(60) Provisional application No. 60/674,450, filed on Apr. 25, 2005.

(51) Int. Cl. G06F 17/30

(52) U.S. Cl. 707/5

(57) ABSTRACT

A system for searching for information is disclosed. The system comprises a search module that obtains a set of results that is responsive to a query. The system also includes a biasing module that ranks members of the set of results based at least in part upon a member of a set of information derived from prior information-gathering tasks. Methods for using such system are also provided.

### CROSS-REFERENCE TO RELATED APPLICATION

This application claims benefit under 35 U.S.C. § 119(e) from U.S. Provisional Patent Application Ser. No. 60/674,450 entitled “PAGE-BIASED SEARCH” and filed on Apr. 25, 2005. The entirety of that application, including all attachments or exhibits thereto, is hereby incorporated by reference.

### BACKGROUND

Typically, the information available on Web sites and servers is accessed using a Web browser executing on a computer. For example, a user can launch a Web browser and access a Web site by entering a Uniform Resource Locator (URL) of the Web site into an address bar of the Web browser and pressing the enter key on a keyboard or clicking a button with a mouse. The URL typically includes three pieces of information that facilitate access: a protocol (set of rules and standards for the exchange of information in computer communication) string, a domain name (often based on the name of an organization that maintains the Web site), and a path to the desired document within the domain.

In some instances, the user knows the name of the site or server or the URL to the site or server that the user desires to access. In such situations, the user can access the site as described above by entering the URL in the address bar and connecting to the site. However, in most instances the user does not know the URL or the site name. In many of those cases, the user does not even know that the site exists. To find the site or the URL of the site, the user employs a search function to locate a particular site based on keywords provided by the user.

The user can enter keywords into a general search engine that will search the entirety of the World Wide Web (or a significant portion of the Web) and return URLs of sites that the search engine determines to be related to the entered keywords. Often however the general search engine will return URLs of a substantial number of sites that are wholly unrelated to the particular interests of the user. For example, if the user searching for information related to computer virii searched using the keyword “virus,” the user typically would receive information relating to biological virii as well as computer virii. Information related to biological virii can even be presented before, or ranked higher than, the information related to computer virii desired by the user. The user can thereafter scroll through a plurality of returned sites to attempt to determine if the sites are related to the interests of the user. Scrolling through returned results can be extremely time-consuming and frustrating to the user as general search engines can return a substantial number of sites when performing a search. The user can attempt to narrow the search by structuring a query, such as by using a combination of Boolean operators, but it can be difficult to construct an appropriate Boolean search that will result in a return of sites containing relevant information.

Some conventional general search engines attempt to infer what a user is searching for based upon keywords. For instance, if a user entered the term “virus” into the general search engine, the search engine can return a plurality of sites together with suggestions for narrowing the search. More particularly, the search engine could return a plurality of suggestions, such as “do you want to search for a computer virus?” or “do you want to search for a biological virus?” For many searches (especially for more detailed and specific searches), this conventional method requires selecting a continuing hierarchy of suggested searches. Even with this approach, returned sites can still lack relevant information. Furthermore, the user may desire to locate a site that will not be encompassed by the returned search suggestions.

Users continue to desire the ability to search for information based on what those users each personally find relevant. Individual users can be unique in their cares and concerns and thus have different relevance criteria. Some technologies permit users to input data to create a user profile that is employed to provide more relevant search results. However, users are often too busy to take the time to provide lengthy information criteria in order to facilitate the search process. Users demand quick and efficient means to return search results that best suit their own unique needs, thereby increasing their satisfaction with their searches.

### SUMMARY

The following presents a simplified summary in order to provide a basic understanding and high-level survey. This summary is not an extensive overview. It is neither intended to identify key or critical elements nor to delineate scope. The sole purpose of this summary is to present some concepts in a simplified form as a prelude to the more detailed description later presented. Additionally, section headings used herein are provided merely for convenience and should not be taken as limiting in any way.

A page-biased search system can use terms from a Web page or other suitable document currently being viewed to modify a search query such that results of that query are biased toward results that are similar to the Web page or other suitable document currently being viewed. The system can use link maps to determine whether a Web page or other suitable document located as a search result is in the same neighborhood as a Web page or other suitable document currently being viewed. A neighborhood can be defined as a group of Web page or other suitable documents that are within a predetermined distance, such as a number of hops or navigation steps, from a viewed Web page or other suitable document. Web pages or other suitable documents that are within the same neighborhood can be ranked more highly than others.

A page-biased search system can use probability-weighted content from a currently-viewed or recently-viewed Web page or other suitable document to bias a search query and locate similar pages. Pages with similar content are ranked more highly than other pages.

In accordance with yet another aspect of the invention, a page-biased search system can use content from a currently-viewed Web page or other suitable document to expand a search query and bias results toward similar pages. Similar pages or documents are ranked more highly than other pages or documents. Items used to expand the search query can be tagged as optional for the search.

In accordance with yet another aspect of the invention, a page-biased search system can use content from previous search queries to expand a search query and bias results toward similar pages. Similar Web pagess or other suitable documents can be ranked more highly than dissimilar Web pages or documents. Similarity of Web pages or documents can be determined using various content-based measures. Items used to expand the search query can be tagged as optional for the search. Ranking of Web pages or documents, including a currently- or previously-viewed Web page or document, can also be taken into account as an expansion term either alone or in combination with other factors.

A page-biased search system can use demographic information to bias search results toward results associated with similar demographics. Demographic information of a user of the page-biased search system, of other viewers of a currently- or previously-viewed Web page or other suitable document or Web site, or a combination of these can be compared with demographic information of viewers of a Web page or document to be included in a set of search results. Web pages or other suitable documents to be included in a set of search results having demographics that are similar to demographics of a user or a currently- or previously-viewed Web pages or documents can be ranked more highly than other Web pages or other suitable documents.

A page-biased search system can use likely browsing paths from a currently- or previously-viewed Web page or other suitable document to bias results toward pages to be included in a set of search results that are likely to be visited after a currently- or previously-viewed Web page or document. Likelihood of a user visiting a Web page or document can be determined from navigation histories of that user or a group of users. Web pages or documents to be included in a set of search results that appear in previous navigation paths from a currently- or previously-viewed Web page or other suitable document can be deemed to be more likely to be visited. Web pages or documents that are more likely to be visited can be ranked more highly than other pages.

A page-biased search system can use term associations to infer or predict likely user actions and search desires. Such term associations can be applied to searches to obtain Web pages or other suitable documents to be included in a set of search results. Web pages or documents in the set of search results can include those that ordinarily would not have been included in a set of search results based solely upon a keyword search entered by a user. Results deemed to be in accordance with user actions or desires can be ranked more highly than other pages.

The disclosed and described components and methods comprise one or more of the features hereinafter described and particularly pointed out in the claims. The following description and the annexed drawings set forth in detail certain specific illustrative components and methods. However, these components and methods are indicative of but a few of the various ways in which the disclosed components and methods can be employed. Specific implementations of the disclosed and described components and methods can include some, many, or all of such components and methods, as well as their equivalents. Variations of the specific implementations and examples presented herein will become apparent from the following detailed description when considered in conjunction with the drawings.

### BRIEF DESCRIPTION OF THE DRAWINGS

FIG. 1 is a system block diagram of a page-biased search system.

FIG. 2 is a system block diagram of a page-biased search system.

FIG. 3 is a system block diagram of a page-biased search system.

FIG. 4 is a system block diagram of a page-biased search system.

FIG. 5 is a system block diagram of a page-biased search system.

FIG. 6 is a system block diagram of a page-biased search system.

FIG. 7 is a system block diagram of a page-biased search system.

FIG. 8 is a system block diagram of a page-biased search system.

FIG. 9 is a flow diagram depicting a method that can be employed in conjunction with components disclosed or described herein.

FIG. 10 is a flow diagram depicting a method that can be employed in conjunction with components disclosed or described herein.

FIG. 11 is a flow diagram of a method that can be employed in conjunction with components disclosed or described herein.

FIG. 12 is a flow diagram depicting a general processing flow of a method that can be employed in conjunction with components disclosed or described herein.

FIG. 13 is a flow diagram depicting a general processing flow of a method that can be employed in conjunction with components disclosed or described herein.

FIG. 14 is a flow diagram depicting a general processing flow of a method that can be employed in conjunction with components disclosed or described herein.

FIG. 15 is a flow diagram depicting a general processing flow of a method that can be employed in conjunction with components disclosed or described herein.

FIG. 16 is a flow diagram depicting a general processing flow of a method that can be employed in conjunction with components disclosed or described herein.

FIG. 17 illustrates an exemplary networking environment.

FIG. 18 illustrates an exemplary operating environment.

### DETAILED DESCRIPTION

As used in this application, the terms “component,” “system,” “module,” and the like are intended to refer to a computer-related entity, such as hardware, software (for instance, in execution), and/or firmware. For example, a component can be a process running on a processor, a processor, an object, an executable, a program, and/or a computer. Also, both an application running on a server and the server can be components. One or more components can reside within a process and a component can be localized on one computer and/or distributed between two or more computers.

Disclosed components and methods are described with reference to the drawings, wherein like reference numerals are used to refer to like elements throughout. In the following description, for purposes of explanation, numerous specific details are set forth in order to provide a thorough understanding of the disclosed subject matter. It may be evident, however, that certain of these specific details can be omitted or combined with others in a specific implementation. In other instances, certain structures and devices are shown in block diagram form in order to facilitate description. Additionally, although specific examples set forth may use terminology that is consistent with client/server architectures or may even be examples of client/server implementations, skilled artisans will appreciate that the roles of client and server may be reversed, that the disclosed and described components and methods are not limited to client/server architectures and may be readily adapted for use in other architectures, specifically including peer-to-peer (P2P) architectures, without departing from the spirit or scope of the disclosed and described components and methods. Further, it should be noted that although specific examples presented herein include or reference specific components, an implementation of the components and methods disclosed and described herein is not necessarily limited to those specific components and can be employed in other contexts as well.

It should also be appreciated that although specific examples presented may describe or depict systems or methods that are based upon components of personal computers, the use of components and methods disclosed and described herein is not limited to that domain. For example, the disclosed and described components and methods can be used in a distributed or network computing environment. Additionally or alternatively, the disclosed and described components and methods can be used on a single server accessed by multiple clients. Those of ordinary skill in the art will readily recognize that the disclosed and described components and methods can be used to create other components and execute other methods on a wide variety of computing devices.

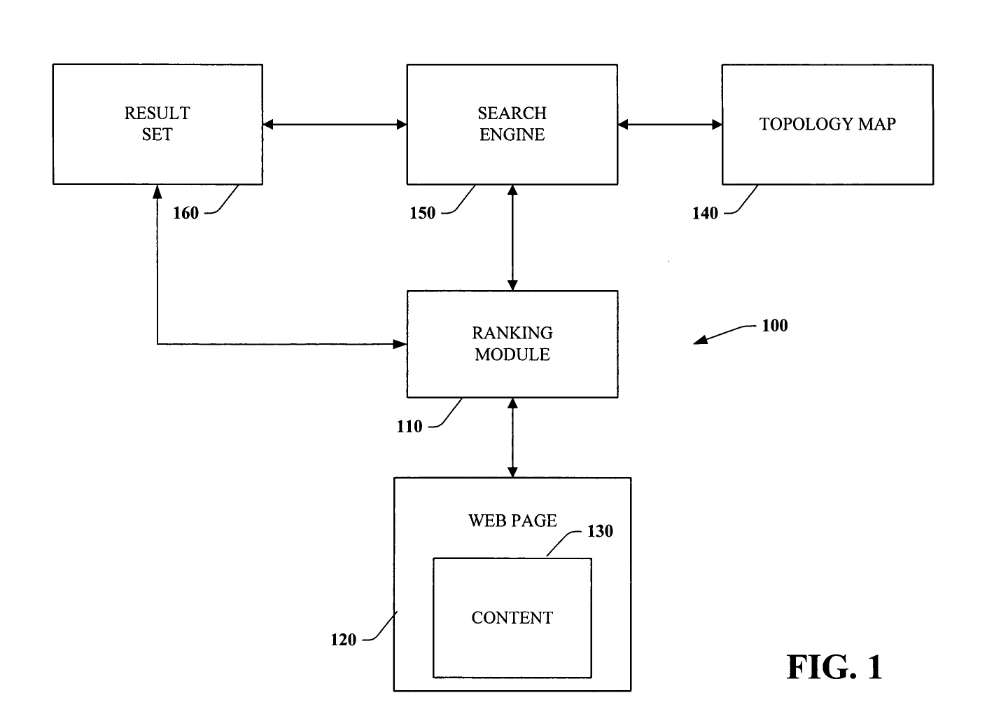

FIG. 1 is a system block diagram of a page-biased search system 100. The page-biased search system 100 includes a ranking module 110 that can use information to adjust rankings of query search results for presentation to a user. The ranking module 110 can access a Web page 120 that includes some content 130. Web pages can be static HTML documents or dynamically-generated documents in HTML format or another format such as DHTML or XML that can be rendered for display to user. The Web page 120 can be replaced with another suitable document. Suitable documents can include any document from which appropriate information, such as text, images, or metadata, can be obtained. Specifically included are text documents, images, audio files, and video files, including multimedia files, among others.

It should be noted that as used herein, the term Web page can be interchanged with the term document where appropriate. Although specific examples presented herein make use of Web pages as part of a specific implementation to provide illustration or context, systems, components and methods disclosed and described in this document are not limited to use only with Web pages. Those of ordinary skill in the art will recognize from reading this disclosure that these disclosed and described systems, components, and methods can readily be applied to other types of information sources, such as other types of documents, either with or without modifications that are within the ability of a person of ordinary skill in this area.

Web pages or documents can include a number of hyperlinks to other Web pages or documents and can themselves be targets of hyperlinks from other Web pages or documents. Hyperlinks to and from Web pages or documents are unidirectional. From the perspective of a single Web page or document, a hyperlink can be viewed as a link that is inbound to the page from another page or an in-link. Alternatively, a hyperlink within a Web page or document that points to another Web page or document is an outbound link or an out-link.

Hyperlinked documents on the World Wide Web or some other grouping of information sources or documents can be depicted in a directional graph sometimes referred to as a topology map. This directional graph can include one or more cycles. Such a topology map is depicted in block form in FIG. 1 as topology map 140. A topology map of the entire World Wide Web can be broken down into a number of smaller maps, each of which is a subset of the map that represents the entire World Wide Web. Although in theory any Web page or document can link to any other Web page or document, in practice Web pages or documents generally link to other Web pages or documents that have similar themes or content. This fact can be exploited to create a topology map of a neighborhood of Web pages or documents that are within a certain distance from a central page. In Web terms, a distance between two Web pages or documents is generally expressed as a number of links that must be followed to navigate from an origin page to a destination page.

The page-biased search system 100 also includes a search engine 150 that can accept a query, search for information that is responsive to that query, and create a set of responsive results. The search engine 150 can access information from the topology map 140 when gathering results that are responsive to a search query. Results from the search engine 150 are placed into a result set 160 that can be accessed by the ranking module 110.

In operation, the page-biased search system 100 can function as follows. The search engine 150 obtains a request to locate information, such as a query for Web pages or documents that are relevant to terms in the query. The search engine 150 locates responsive Web pages or documents and places identifiers such as URLs of such responsive Web pages or documents into the result set 160. The ranking module 110 accesses the Web page 120 and the result set 160. The ranking module 110 examines a neighborhood topology of the Web page 120 by accessing information from the topology map 140. The ranking module 110 also accesses a neighborhood topology for each of the responsive Web pages or documents in the result set 160. A calculation is then made of the distance of each Web page or document in the result set 160 from the Web page 120. The ranking module 110 ranks each member of the result set 160 based upon its distance from the Web page 120. Web pages or documents of the result set 160 that are closest to the Web page 120 are ranked highest. Conversely, Web pages or documents of the result set 160 that are the furthest distance away from the Web page 120 are ranked lowest.

The entire result set 160 does not have to be ranked using a topological distance. The search engine 150 can perform a preliminary ranking based upon other factors. Results from the search engine 150 can be added to the result set 160 using a preliminary ranking that is based on a factor or factors other than topological distance. The ranking module 110 can then re-rank one or more members of the result set 160 using topology information. When a preliminary ranking by the search engine 150 is used, a subset of the result set 160 can be ranked. For example, only the 20 highest-ranked pages, using the preliminary ranking of the search engine 150, can be re-ranked by the ranking module 110. A cut off for the number of pages of the result set 160 to be re-ranked can be applied as a user-selectable preference. Appropriate user interface elements to select such a preference can be employed.

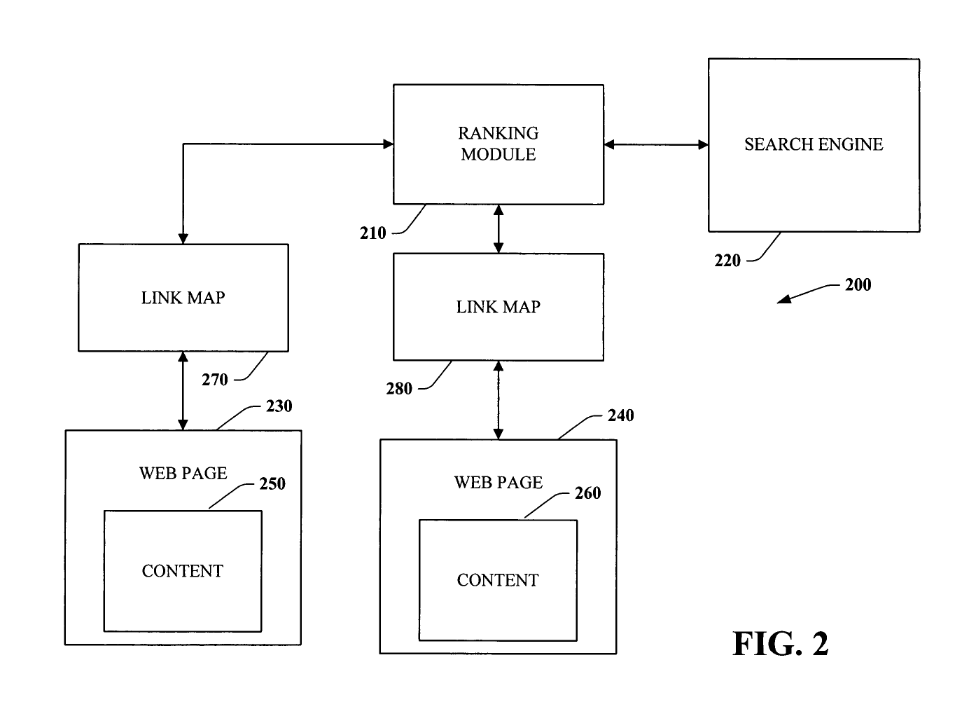

FIG. 2 depicts a page-biased search system 200. The page-biased search system 200 includes a ranking module 210 that can communicate with a search engine 220. The ranking module 210 can also access information about Web pages 230, 240. Web pages 230, 240 each include content 250, 260, respectively. Additionally, each Web page 230, 240 has an associated link map 270, 280. Each link map 270, 280 is a map or other listing or representation of in-links and out-links associated with its respective Web page and defines a topological neighborhood of the respective Web page 230, 240.

The ranking module 210 can assign a rank to a Web page or other suitable document, such as the Web page 240, by comparing a link map of a Web page or document, such as the link map 280 of the Web page 240, to a link map of a recently viewed Web page or document, such as a link map 270 of the Web page 230. Link maps, such as the link map 270 and the link map 280, can be created by assigning nodes to destinations each in-link and out-link for some maximum link depth. Various graph comparison algorithms can be used to compare link maps. Highly similar maps result in a high ranking for a located Web page or document. Other representations for link maps, as well as other appropriate comparison methods, can also be employed.

Two Web pages or documents that include content pertaining to similar themes or topics can often link to each other or to still other related Web pages or documents. Interlinked Web pages or documents on the same or similar topics can form link clusters or neighborhoods. Within these link clusters or neighborhoods, Web pages or documents can share highly similar link maps. The ranking module 210 can rank Web pages or documents within the same link cluster or neighborhood as a Web page or document that is currently being viewed or has recently been viewed more highly than a Web page or document lying outside the cluster or neighborhood of the currently- or recently-viewed Web page or document.

In operation, the page-biased search system 200 can function as follows. The page-biased search system 200 uses attributes of a Web page or other suitable document either currently being viewed or that recently was viewed to weight search results that include other Web pages or documents. The ranking module 210 accesses a Web page or document currently being viewed, such as the Web page 230. The Web page 230 can have a pre-existing link map, such as the link map 270, or the ranking module 210 can create such a link map upon demand. Additionally or alternatively, a persistent link map for the Web page or being viewed can be maintained and refreshed periodically. Such refresh tasks can be performed automatically, in accordance with a predefined schedule, or manually, among others. When the search engine 220 provides results from a search query, the ranking module 210 can access each of the Web pages or documents in the results, such as the Web page 240, to obtain a previously created link map, such as the link map 280, or to dynamically create a link map for that Web page or document.

The ranking module 210 compares the link map 270 of the Web page 230 that is currently being viewed, with the link map 280 of the Web page 240 to be ranked. A similarity measure is then calculated that represents a degree of similarity between the link maps 270, 280. Various map comparison algorithms can be used to calculate the similarity measure. In large part, specific details of a comparison algorithm to be used will depend upon the specific implementation of the link maps employed. The ranking module 210 will then re-rank search results based upon the similarity measure.

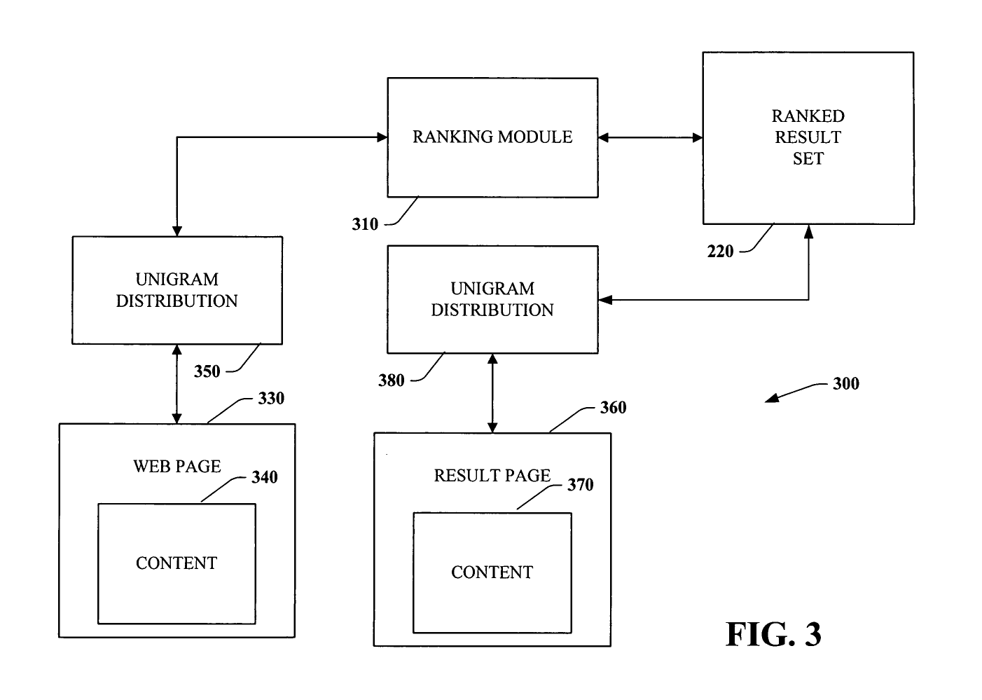

FIG. 3 illustrates a page-biased search system 300. The page-biased search system 300 includes a ranking module 310 that can access a ranked result set 320 that contains information, such as a group of URLs of Web pages or other suitable documents, that each are deemed to be responsive to a search query. The ranking module 310 can also access a currently-viewed Web page 330 that includes some content 340. As in other examples, the Web page 330 can be replaced with another suitable document or information source. The currently-viewed Web page 330 can have an associated unigram distribution 350. The unigram distribution 350 can be a probabilistic list of terms that are included in the content 340 and can be created using an algorithm such as the term frequency-inverse document frequency (TF-IDF) algorithm. Another suitable algorithm, or a modification of the TF-IDF algorithm, can also be used.

The ranking module 310 can also access a result page 360 that includes some content 370. The result page 360 also can have an associated unigram distribution 380 that can be created in a similar fashion as the unigram distribution 350. The ranking module 310 can compare the unigram distribution 380 with the unigram distribution 350 to calculate a similarity measure. Various methods for comparing the unigram distribution 350 with the unigram distribution 380 can be used, along with a variety of similarity measures of the two unigram distributions. Based at least in part upon the similarity measure, the ranking module 310 can assign a rank to the results page 360.

In operation, the page-biased search system 300 can function as follows. The ranking module 310 accesses, or alternatively creates, a unigram distribution for a Web page or other suitable document currently being viewed by a user, such as the unigram distribution 350 of the Web page 330. The ranking module 310 accesses a set of results from a search query, such as the ranked result set 320. It should be noted that results within the ranked result set 320 can be previously or initially ranked by a search engine or can be unranked. In the case when results are unranked, results of a search typically will be presented in some order, even if that order is simply the order in which the results were located. In this case, results can simply be treated as ranked.

The ranking module 310 accesses, or alternatively creates, a unigram distribution for each member of the set of results, such as the unigram distribution 380 of the result page 360. The ranking module 310 calculates a similarity measure by comparing the unigram distribution of the currently-viewed Web page or document with the unigram distribution of the result page. This process is repeated for each member of the ranked result set 320. Members of the ranked result set 320 are then ranked by the ranking module 310 based at least in part upon the similarity measure.

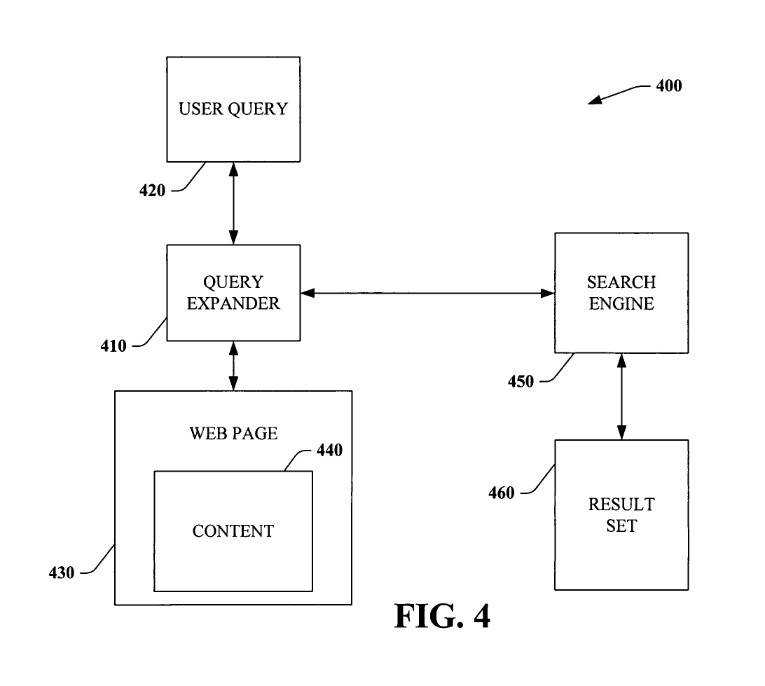

FIG. 4 depicts a page-biased search system 400. The page-biased search system 400 includes a query expander 410 that can access a user query 420 and a Web page 430. As with other examples, the Web page 430 can be replaced with another suitable document or information source. The Web page 430 includes some content 440. The query expander 410 can use terms from the content 440 of the Web page 430 to expand the user query 420. A search engine 450 can obtain an expanded query from the query expander 410 and can use that expanded query to find responsive information. Such responsive information can then be placed into a result set 460 by the search engine 450. The user query 420 can take a variety of forms. For example, the user query 420 can be a simple list of keywords or can be more complex, such as a structured query in some query language, or can take another suitable form. Information obtained by the query expander 410 from the Web page 430 can be a simple list of words appearing in the content 440 of the Web page 430, can be a probabilistic list of words from the Web page 430, can be a unigram, such as one of the unigrams described in conjunction with FIG. 3, or can be some other appropriate form of information.

It should be noted that there are a number of ways in which a query can be expanded. For example, search terms, including search terms entered by a user at a user interface or search terms obtained from content of a Web page or other suitable document such as the Web page 430, can be used as prefixes, suffixes, or roots for constructing queries. Terms that are related to such obtained terms can also be used. For instance, if a term from a user is the word “car,” the term “automobile” can be added as well. Related terms can be obtained from a dictionary or thesaurus look-up or another means. Various combinations of these and other techniques can be used to expand or otherwise modify a query.

In operation, the page-biased search system 400 can function as follows. The query expander 410 accepts the user query 420 and combines the user query 420 with the additional information from the Web page 430 to form an expanded query. The additional information can be used as a prefix, a suffix, a root, or otherwise to expand the query. The query expander 410 then sends the expanded query to the search engine 450. The search engine 450 uses the expanded query to search a data store for information that is responsive to the expanded query. Responsive information that is located by the search engine is placed into the result set 460. In this manner, search results that include information that is generally responsive to a query can be weighted in favor of information that is similar to information that is currently being, or has recently been viewed.

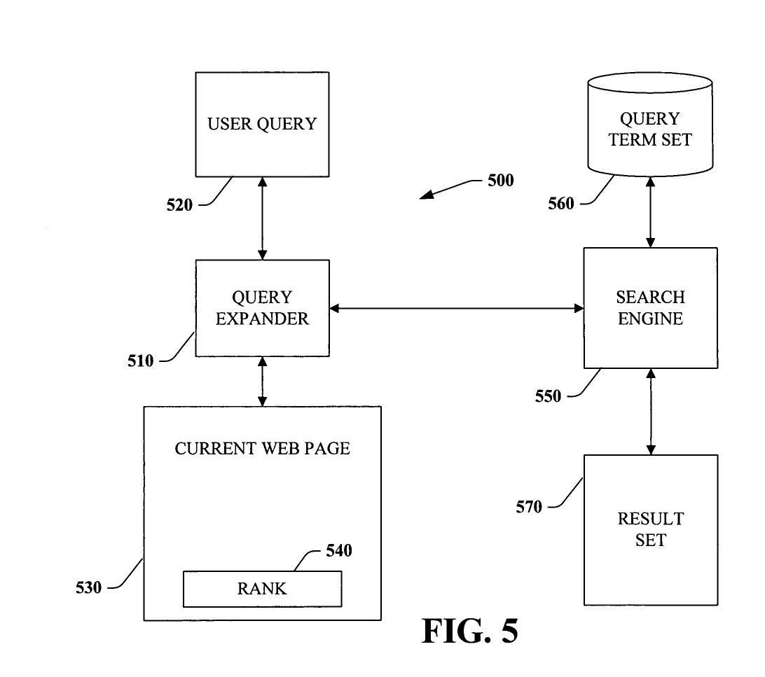

FIG. 5 is a system block diagram of a page-biased search system 500. The page-biased search system 500 includes a query expander 510 that can access a user query 520. At least part of the user query can be entered by a user at some human-computer interface. The query expander 510 can also access a current Web page 530 that has a rank 540 and can use the rank 540 of the current Web page 530 to expand the user query 520 to form an expanded query. As with other examples, the Web page 530 can be replaced with another suitable document or information source. A search engine 550 can accept the expanded query from the query expander 510 and use the expanded query to search for relevant information.

The search engine 550 can also access a query term set 560. The query term set 560 includes a group of terms that have been used in other search queries. The search engine can use terms from other queries in conjunction with the expanded query from the query expander when searching for relevant information that is responsive to the search query. Such relevant information that is located by the search engine 550 is placed into a result set 570.

The query expander 510 can form an expanded query by combining the user query 520 with the rank 540 of the current Web page 530. The search engine 550 can use the rank 540 to obtain additional query terms from the query term set 560. In this example, the search engine 550 can obtain terms from previous queries that produced responsive results that were ranked at least as highly as the rank 540 of the current Web page 530. The search engine 550 can then augment the expanded query from the query expander 510 with additional terms from the query term set 560. By so augmenting the user query 520, results obtained by the search engine 550 can be weighted in favor of results that have at least a specific ranking.

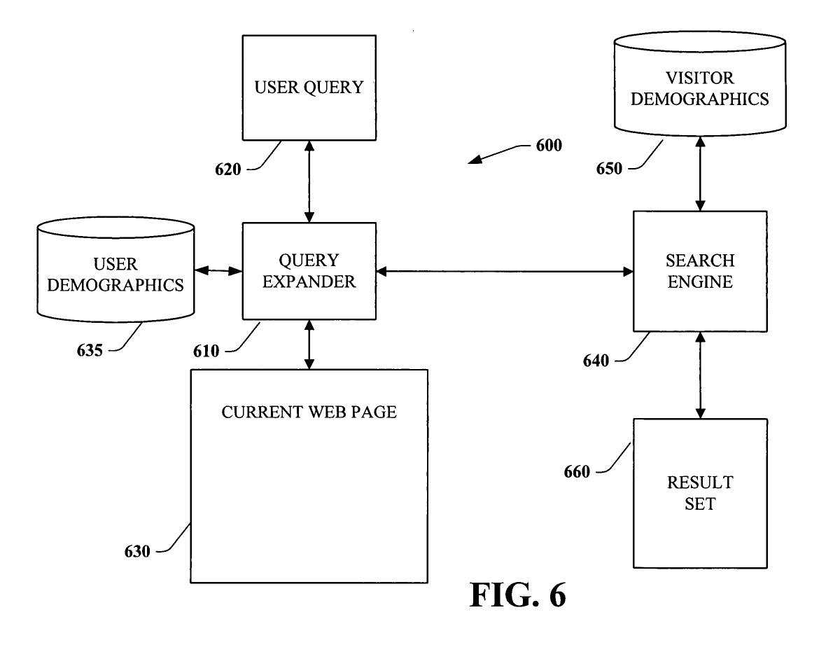

FIG. 6 is a system block diagram of a page-biased search system 600. The page-biased search system 600 includes a query expander 610 that can access a user query 620. The query expander 610 can also access both a currently- or previously-viewed Web page 630 and user demographic information 635. As with other examples, the Web page 630 can be replaced with another suitable document or information source. The user demographic information 635 can be demographic information about a specific user who is currently operating the system, demographic information about visitors to the currently- or previously-viewed Web page 630, or can be some other suitable demographic information. The user demographic information 635 can be used by the query expander 610 to expand the user query 620.

A search engine 640 can access a data store of visitor demographic information 650. The data store of visitor demographic information 650 can include demographic information for the visitors to the current Web page 630 and other Web pages or documents. The search engine 640 can accept the expanded query from the query expander 610. When obtaining search results that are responsive to the expanded query, the search engine 640 can use information from the data store of visitor demographic information 650 that relates to individual search results to weight such results in favor of those having demographic information that is similar to the user demographic information 635. Weighted results can then be placed into the result set 660. Items of the result set 660 having demographics that are most similar to the user demographic information 635 can be ranked more highly than items with dissimilar demographic information.

To measure similarity between or among sets of demographic information, a variety of approaches can be used. One approach that is possible is to calculate a demographic score that can be applied to a Web page or other suitable document to be ranked. This demographic score can result from comparisons of values of various factors or pieces of demographic information such as age, gender, level of education, level of income, or geographic information, among others. Comparisons can be made against demographic information of a user, of a currently- or previously-viewed Web page or document, or against another reference set of demographic information.

In one possible scoring system, a point can be awarded for each matching demographic factor. A match does not have to be an exact match and can be an approximate match or a category match. Web pages or documents that receive high demographic scores can be ranked more highly than Web pagea or documents that receive lower demographic scores. Other scoring systems, including more sophisticated scoring systems that can use weighted or other adjusted factors, can also be used. Additionally or alternatively, demographic-based scoring can be combined with other ranking techniques to calculate an overall rank for a Web page or other document.

In use, the page-biased search system 600 can function as follows. The query expander 610 obtains the user query 620 and augments that query with the user demographic information 635. The augmented query is then sent by the query expander 610 to the search engine 640. The search engine 640 locates information that is responsive to the augmented query and uses information from the data store of visitor demographic information 650 that pertains to the located information to assign a rank to the located information. A rank is assigned by comparing demographic information for the located information with the user demographic information 635. A simple scoring system can be used when comparing demographic information, such as assigning various point values to matching items. More complex comparison or scoring systems can be used, among other systems. When a simple scoring system as described is used, located information items having the highest scores will obtain the highest ranks. Generally, located information having associated demographic information that is most similar to the user demographic information 635 will be ranked the highest.

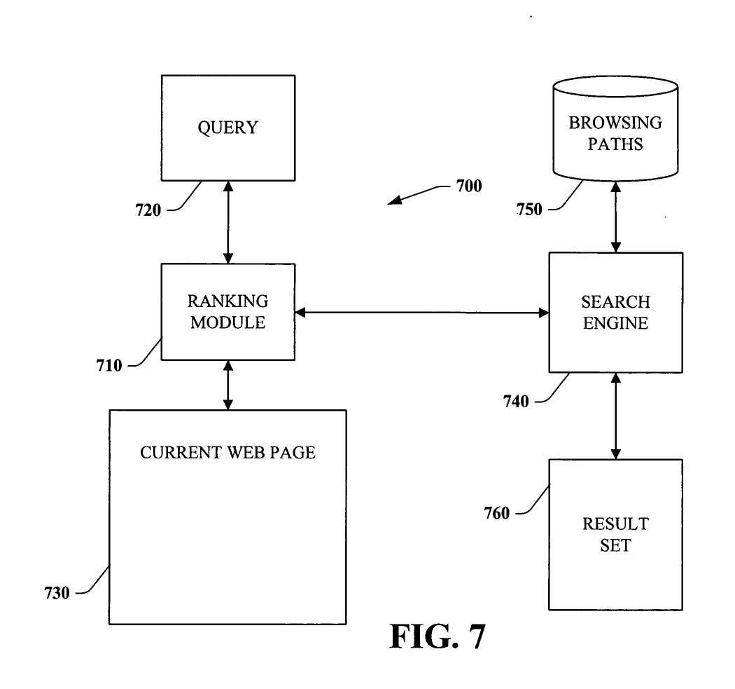

Turning now to FIG. 7, a page-biased search system 700 is shown. The page-biased search system 700 includes a ranking module 710 that can access a query 720 and a current Web page 730. As with other examples, the Web page 730 can be replaced with another suitable document or information source. Information that the ranking module 710 obtains from the current Web page 730 can include a location, such as a full URL, a qualified URL, or merely a domain name that is associated with the Web page 730.

A search engine 740 can obtain the query 720 to perform a search for responsive information. The search engine 740 can also access a data store of likely browsing paths 750. The data store of likely browsing paths 750 can include information regarding common or likely browsing paths that a user can take from the current Web page 730. It should be noted that is not necessary that a destination on a likely browsing path from the current Web page 730 be reachable by clicking on a hyperlink in the current Web page 730. A destination on a browsing path can be navigated to by entering a URL in an address bar, by clicking on a hyperlink from a search result Web page or document, or by using another appropriate method.

The search engine 740 can obtain results that are responsive to the query 720. These results can then be weighted using information from the data store of likely browsing paths 750. Such weighting can be as simple as checking to see it whether a result is on a likely browsing path from the current Web page 730. Another possible approach is to assign a score to a search result based first upon whether the result is on a browsing path and second upon a distance along the browsing path from the current Web page 730. Distance can be calculated as a number of navigation steps or hops than necessary to go ahead from the current Web page 730 along the browsing path to the result. The search engines 740 can then rank search results based upon the weight assigned and place such results in a result set 760. Such ranking can be combined with other ranking techniques to obtain an overall rank for a Web page or document.

An example of how the page-biased search system 700 can operate follows. The search engine 740 obtains the query 720 and a location of the current Web page 730. The search engine 740 performs a search for Web pages or other suitable documents that have content that is responsive to the query 720. Located Web pages or other documents are placed in the result set 760. For each located Web page or other document that is deemed to be responsive, the search engine 740 checks to see whether the Web page or other document is located on a likely browsing path from the current Web page 730. If so, the search engine 740 calculates a distance along the likely browsing path from the current Web page 730 to the located Web page or other document. The search engine 740 then calculates a score to be applied to locate a Web page or document. The score is based in least in part upon information derived from the likely browsing paths, specifically, location on the browsing path and distance from the current Web page 730. Located Web pages or documents are then ranked by the search engine 740 using the score.

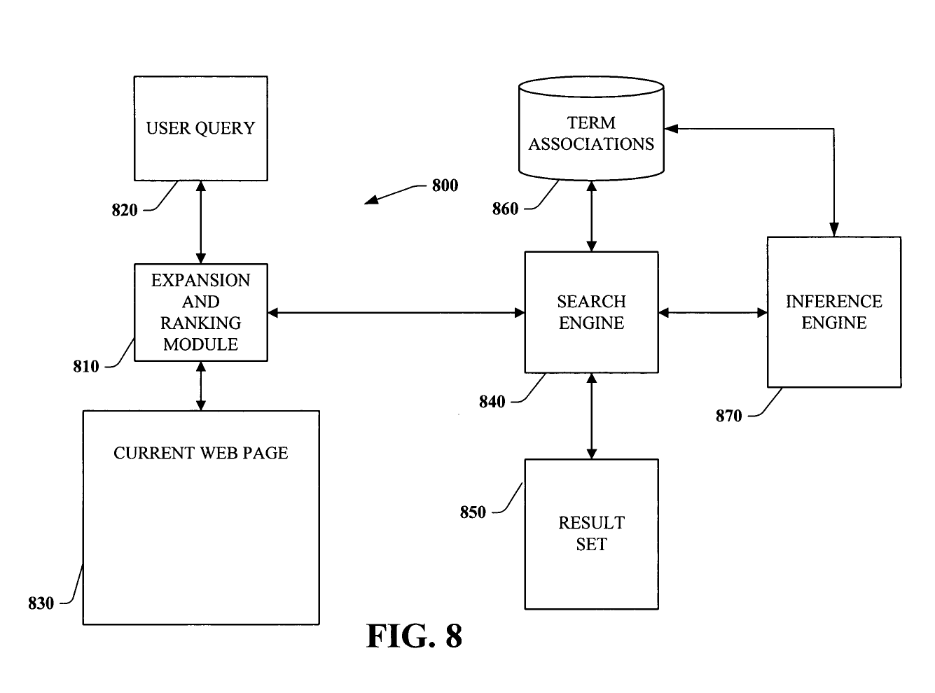

FIG. 8 is a system block diagram of the page-biased search system 800. The page-biased search system 800 includes an expansion in ranking module 810 that can access the user query 820 and a current Web page 830. As with other examples, the Web page 830 can be replaced with another suitable document or information source. In this example, content from the current Web page 830, such as keywords, concepts, or other information deemed important, can be used by the expansion and ranking module 810 to expand the user query 820. An expanded user query can be sent by the expansion ranking module 810 to a search engine 840. A search engine 840 can access a term association data store 860 and an inference engine 870. Results responsive to the expanded query can be placed in a result set 850.

Term associations of the term association data store 860 can be parings or groupings of terms that have logical associations with each other. Such term associations can be used to infer or predict user actions in connection with information search tasks. These term associations can also be used to provide a search context to improve search results. For example, if a user is on a current Web page or using a document that includes the term “space,” and issues a query for “Saturn,” the term association between “Space” and “Saturn” suggests that the user is searching for information dealing with the planet Saturn and not the mythological figure Saturn. In this case, Web pages or other documents dealing with the planet Saturn will be ranked more highly than Web page or other documents dealing with mythology.

As another example, if the user is on a current Web page or using a document that includes the words “Boston, Mass.” and performs a search based on the term “Hotel,” it can be inferred that the user is planning a trip. In this case, travel-related Web sites, such as sites that allow users to make a travel and hotel reservations, can be ranked more highly than hotel Web sites. Another option is to automatically redirect the user to a travel-related Web site. Such ranking or redirection can be combined with advertising or marketing efforts to focus user attention on preferred Web sites.

The disclosed and described components, for example in connection with matching or inference tasks, can employ various artificial intelligence-based schemes for carrying out various aspects thereof. For example, inference or likely search terms or matching of topological maps or sets of demographic information, among other tasks, can be carried out by a neural network, an expert system, a rules-based processing component, or a support vector machine.

A classifier is a function that maps an input attribute vector, X=(x₁, x₂, x₃, x₄, . . . xₙ), to a confidence that the input belongs to a class, that is, f(X)=confidence(class). Such a classification can employ a probabilistic and/or statistical-based analysis (for example, factoring into the analysis utilities and costs) to prognose or infer an action that a user desires to be automatically performed. In the case of a page-biased search system, for example, attributes of a reference set of information to be used in a comparison can be used to determine whether a similar set can be considered to match the reference set.

A support vector machine (SVM) is an example of a classifier that can be employed. The SVM operates by finding a hypersurface in the space of possible inputs, which hypersurface attempts to split the triggering criteria from the non-triggering events. Intuitively, this makes the classification correct for testing data that is near, but not identical to training data. Other directed and undirected model classification approaches include, for example, naïve Bayes, Bayesian networks, decision trees, and probabilistic classification models providing different patterns of independence can be employed. Classification as used herein also includes statistical regression that is utilized to develop models of priority.

As will be readily appreciated from the subject specification, components disclosed or described herein can employ classifiers that are explicitly trained (for example, by a generic training data) as well as implicitly trained (for example, by observing user behavior, receiving extrinsic information). For example, SVMs are configured by a learning or training phase within a classifier constructor and feature selection module. Thus, the classifier(s) can be used to automatically perform a number of functions including but not limited to ranking search results.

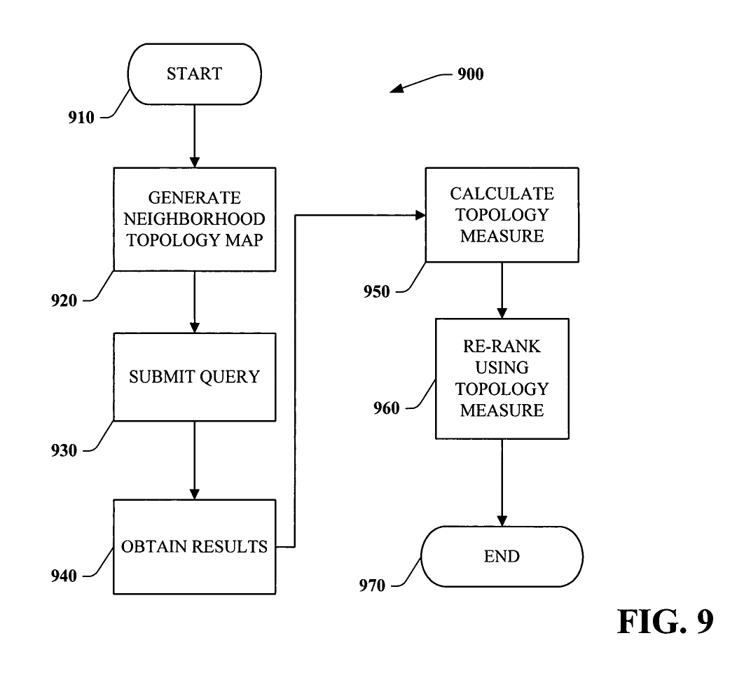

With reference to FIGS. 9-16, flowcharts in accordance with various methods or procedures are presented. While, for purposes of simplicity of explanation, the one or more methodologies shown herein, for example, in the form of a flow chart, are shown and described as a series of acts, it is to be understood and appreciated that neither the illustrated and described methods and procedures nor any components with which such methods or procedures can be used are necessarily limited by the order of acts, as some acts may occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology or procedure.

FIG. 9 is a flow diagram depicting execution of a method 900 that can be used in conjunction with component that are disclosed or described herein. The method 900 can be used to rank Web pages or other suitable documents in a set of search results based at least in part upon distance from a currently- or previously-viewed Web page or document. Specifically, the ranking can be based at least in part upon whether a Web page or document in the set of search results is within a predefined neighborhood of a currently- or previously-viewed Web pages or documents.

Processing of the method 900 begins at START block 910 and continues to process block 920. At process block 920 a neighborhood topology map is generated. The neighborhood topology map can be a map of Web pages or other documents that link to, or are linked from, a specific Web page or document for a specified link depth. Processing continues at process block a 930 where a search query is submitted to a search engine. At process block 940, results of a search using this submitted search query are obtained.

At process block 950 a topology measure is calculated for each search result. The topology measure is a calculation of whether a Web page or document in the set of search results is within a predefined neighborhood of the specific Web page or document. As previously disclosed or described in conjunction with other figures, one possible way of defining a neighborhood is to select a number of navigation hops or links that must be taken to navigate from an origin page such as a currently-or previously-viewed Web page or document, to a destination Web page or document. Web pages or documents that are within that preselected navigation distance are deemed to be in the neighborhood of Web pages or documents. Processing continues at process block 960 where Web pages or documents resulting from the search are re-ranked to using the calculated topology measure. Processing terminates at END block 970.

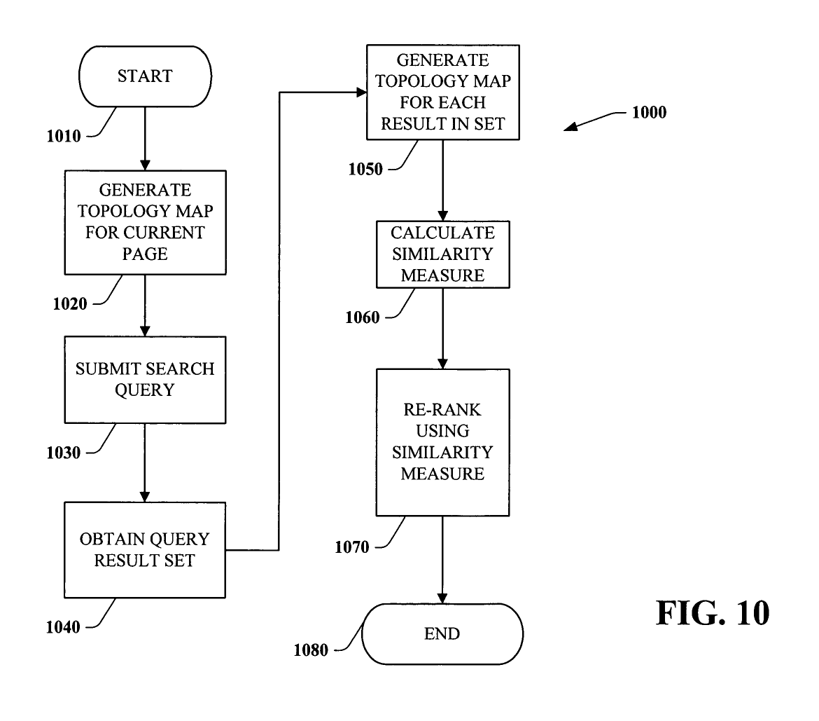

FIG. 10 is a flow diagram showing execution of a method 1000 that can be used in conjunction with component that are disclosed or described herein. The method 1000 can be used to rank Web pages or other suitable documents in a set of search results based at least in part upon similarity to a currently- or previously-viewed Web page or other suitable document. Specifically, similarity can be determined by comparing a topology map for a reference Web page or document such as a currently- or previously-viewed Web page or document with a topology map for a page to be ranked.

Execution of the method 1000 begins at START block 1010 and continues to process block 1020 where a topology map for a currently- or previously-viewed Web page or document is generated. Processing continues at process block 1030 where a search query is submitted to a search engine. At process block 1040, a set of results from a search based on the submitted query is obtained. A topology map for each member of the set of results is generated at process block 1050. This topology map can be a neighborhood map as described in conjunction with other drawings, or can be some other topological representation.

At process block 1060, a similarity measure is calculated by comparing a topology map for a result with the topology map for the currently- or previously-viewed Web page or document. In place of the currently- or previously-viewed Web page or document, any specified Web page or document can be used. This similarity measure can be calculated by comparing a topology map for the result with the topology map for the specified Web page or document. The specified Web page or document can be a currently viewed page, a page that has been previously viewed, or any other specified Web page or document. Any suitable map comparison algorithm or procedure can be used to calculate a measure that can be used to rank an associated Web page or document. At process block 1070, Web pages or other documents in the set of results are re-ranked using the similarity measure. Processing terminates at END block 1080.

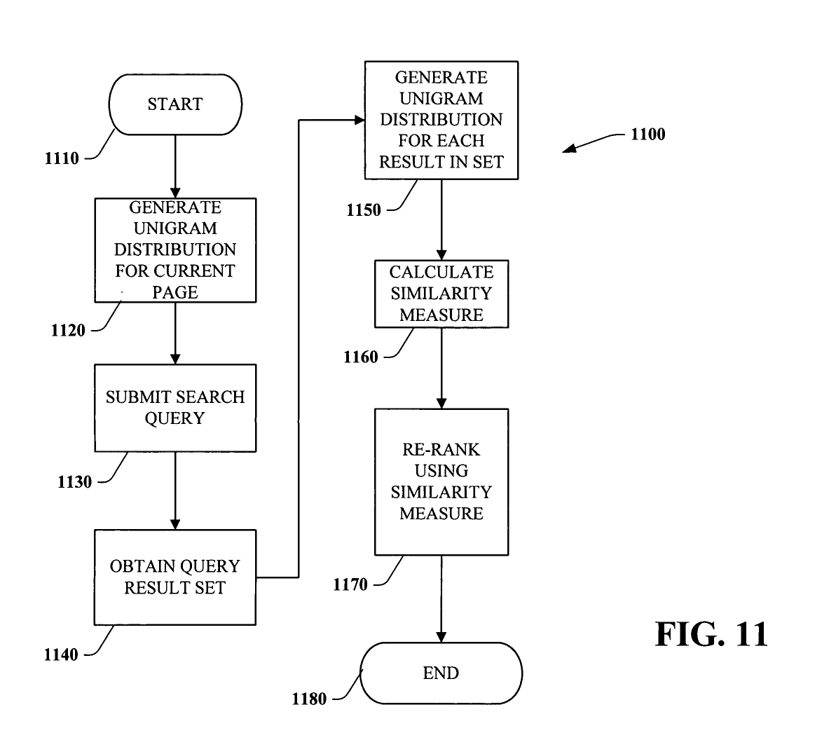

FIG. 11 is a flow diagram depicting processing of a method 1100 that can be used in conjunction with components that are disclosed or described herein. The method 1100 can be used to rank Web pages or other suitable documents in a set of search results based at least in part upon similarity to a currently- or previously-viewed Web page or document. Specifically, similarity can be determined by comparing a unigram distribution for a reference Web page or document, such as a currently- or previously-viewed Web page or document, with a unigram distribution for a page to be ranked.

Processing of the method 1100 begins at START block 1110 and continues to process block 1120. At process block 1120, a unigram distribution for a current Web page or document is generated. A search query is submitted to a search engine at process block 1130. The search engine obtains a set of results and those results are obtained at process block 1140.

Processing continues at process block 1150 where a unigram distribution is generated for each result in the set of results. The unigram distribution can be created using the term frequency-inverse document frequency algorithm or by another suitable method. At process block 1160, a similarity measure is calculated for each result in the set of results by comparing the unigram distribution of the result with the unigram distribution for the current Web page or document. Results of the set of results are re-ranked using the similarity measure at process block 1170 Processing concludes at END block 1180.

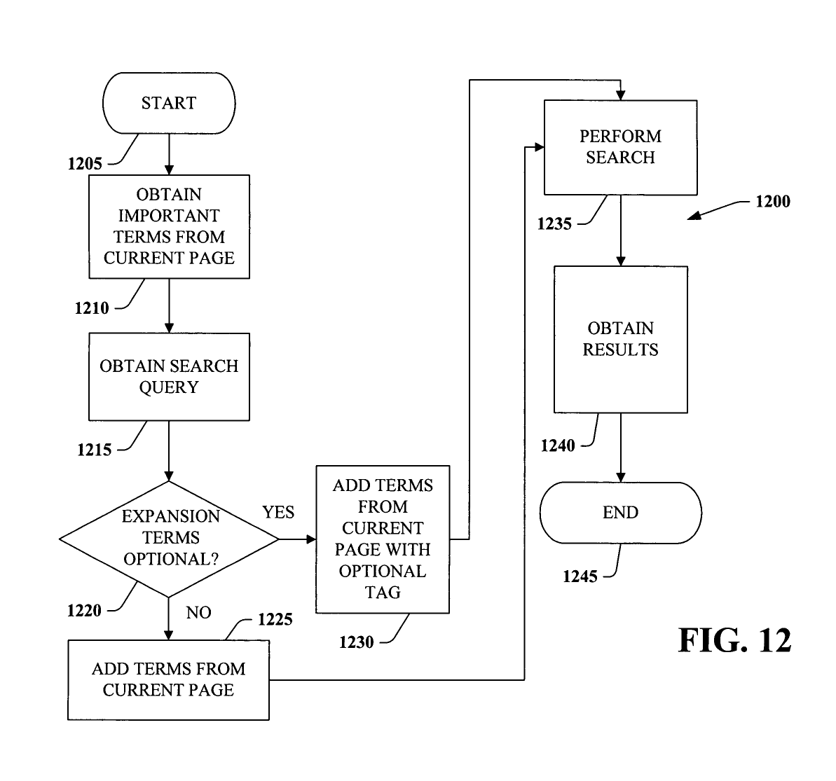

FIG. 12 is a flow diagram showing processing of a method 1200 that can be used in conjunction with components that are disclosed or described herein. The method 1200 can be used to search for Web pages or documents to create a set of search results based at least in part upon an expanded search query. The expanded search query can be created to augment a query entered by a user and improve quality of search results.

Processing of the method 1200 begins at START block 1205 and continues to process block 1210 where important terms from a currently- or previously-viewed Web page or document are obtained. At process block 1215 a search query is obtained. Processing continues to decision block 1220 where a determination is made whether expansion terms to be added to the search query are to be treated as optional. If no, processing continues at process block 1225 where important terms from the currently- or previously-viewed Web page or document are added to the query terms to form an expanded query. If yes, processing continues at process block 1230 where additional terms are added to the query with a tag that designates such terms as optional for the search. Processing from either process block 1225 or process block 1230 continues at process block 1235 where a search is performed using the expanded query. At process block 1240 results of the search are obtained. Processing terminates at END block 1245.

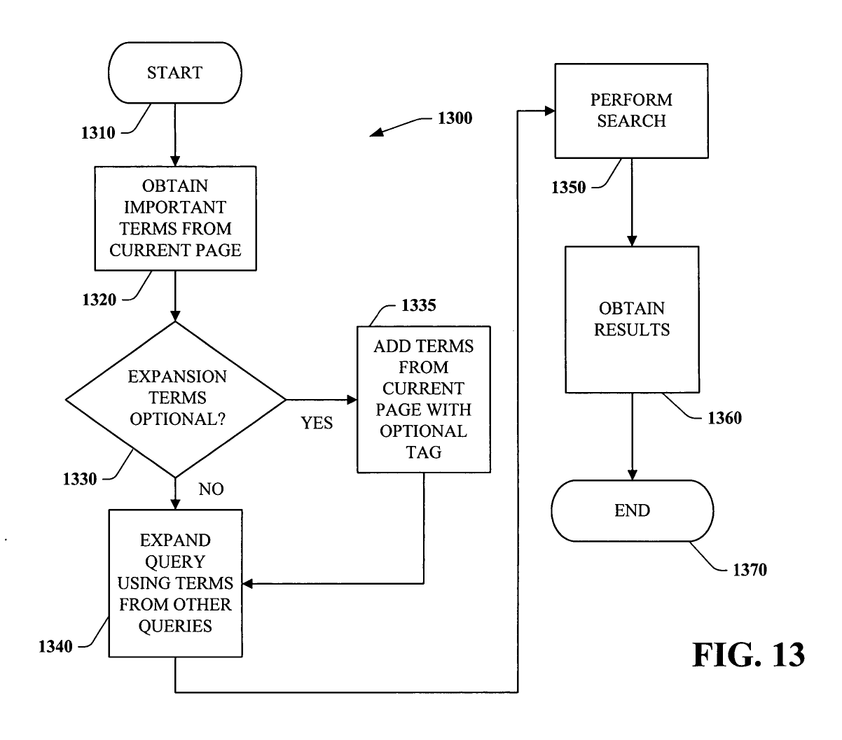

FIG. 13 is a flow diagram showing processing of a method 1300 that can be used in conjunction with components that are disclosed or described herein. The method 1300 can be used to search for Web page or documents to create a set of search results based at least in part upon an expanded search query. The expanded search query can be created from other search queries to augment a query entered by a user and improve quality of search results.

Processing of the method 1300 begins at START block 1310 and continues to process block 1320. The process block 1320, important terms are obtained from a current Web page or document. Processing continues to decision block 1330 where a determination is made whether terms from the current page, which will be used as expansion terms for search query, are to be treated as optional. If yes, the query has a tag that designates expansion terms as optional associated with it at process block 1335. Processing from a negative determination at decision block 1330 or from process block 1335 continues at process block 1340 where the query is expanded. Additional terms to expand the query are obtained from other similar queries that redeemed likely to produce higher quality results. At process block 1350, a search is performed using the expanded query. During the search the tag, if present, is used to determine whether all terms of the query need be present in the search results. Processing continues to process block 1360 where results of the search are obtained. Processing terminates at END block 1370.

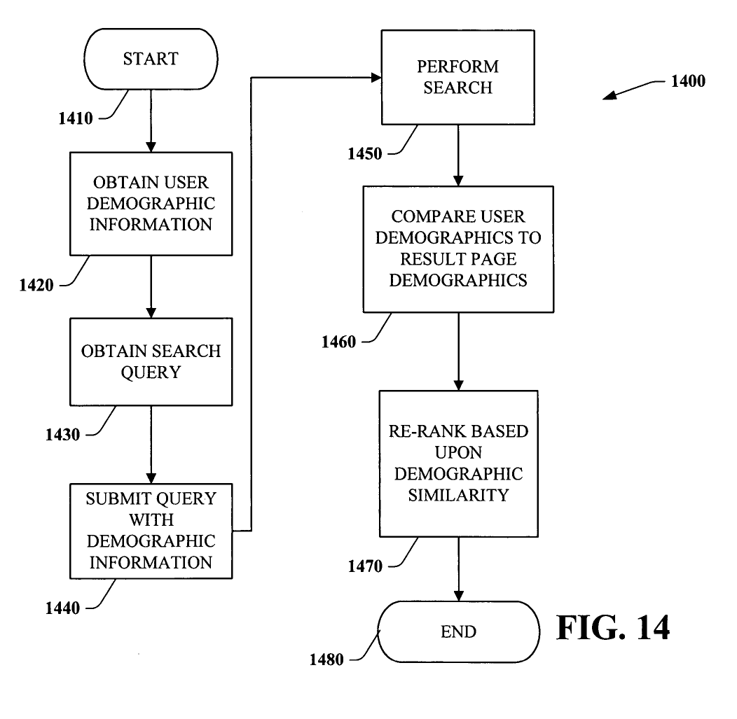

FIG. 14 is a flow diagram showing processing of a method 1400 that can be used in conjunction with components that are disclosed or described herein. The method 1400 can be used to rank Web pages or other suitable documents to be included in a set of search results based at least in part upon demographic information. Specifically, the demographic information can include information that is specific to a user or aggregated across a group of users, or both.

Processing of the method 1400 begins at START block 1410 and continues to process block 1420 where demographic information of a user is obtained. At process block 1430 a search query is obtained. Processing continues at process block 1440 where the search query, along with the demographic information, is submitted to a search engine.

At process block 1450, the search engine performs a search for information that is responsive to the query. At process block 1460, the search engine compares demographics for each page in the results with the user demographic information. Pages in the search results are re-ranked based upon demographic similarity with the user demographics. Processing concludes at END block 1480.

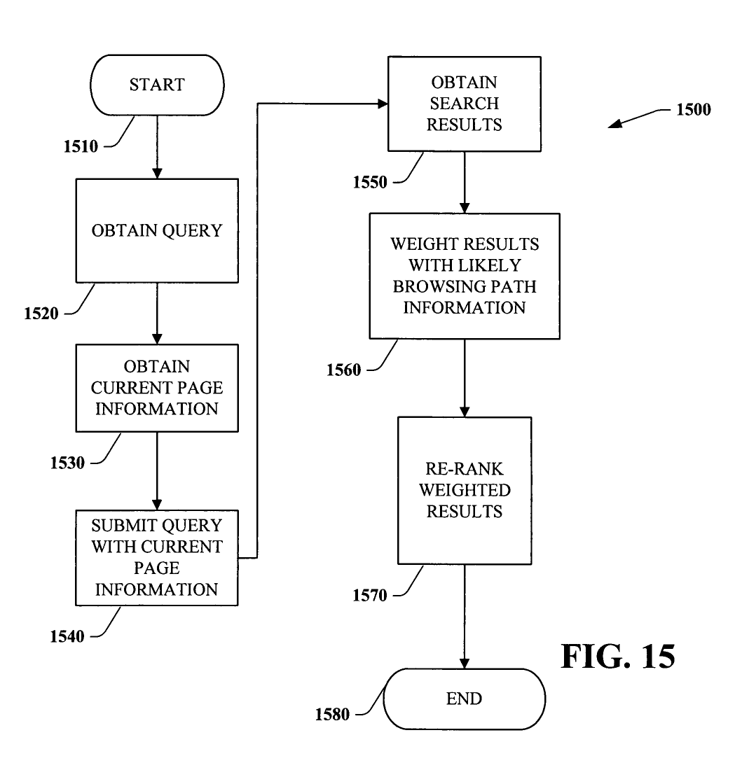

FIG. 15 is a flow diagram showing processing of a method 1500 that can be used in conjunction with components that are disclosed or described herein. The method 1500 can be used to rank Web pages or other suitable documents to be included in a set of search results based at least in part upon likely browsing paths. Specifically, Web sites that are included in a likely browsing path can be ranked more highly than Web sites that are not included in a likely browsing path.

Processing of the method 1500 begins at START block 1510 and continues to process block 1520 where a query is obtained. At process block 1530 a location of a current Web page or document is obtained. Processing continues at process block 1540 where the query is submitted to a search engine along with a location of the current page.

Results of a search based on the query are obtained at process block 1550. At process block 1560, each member of the results is weighted using likely browsing path information. Such information can be merely location on a likely browsing path, location combined with distance from the current page, or other suitable information. Weighted results are re-ranked at process block 1570. Processing concludes at the END block 1580.

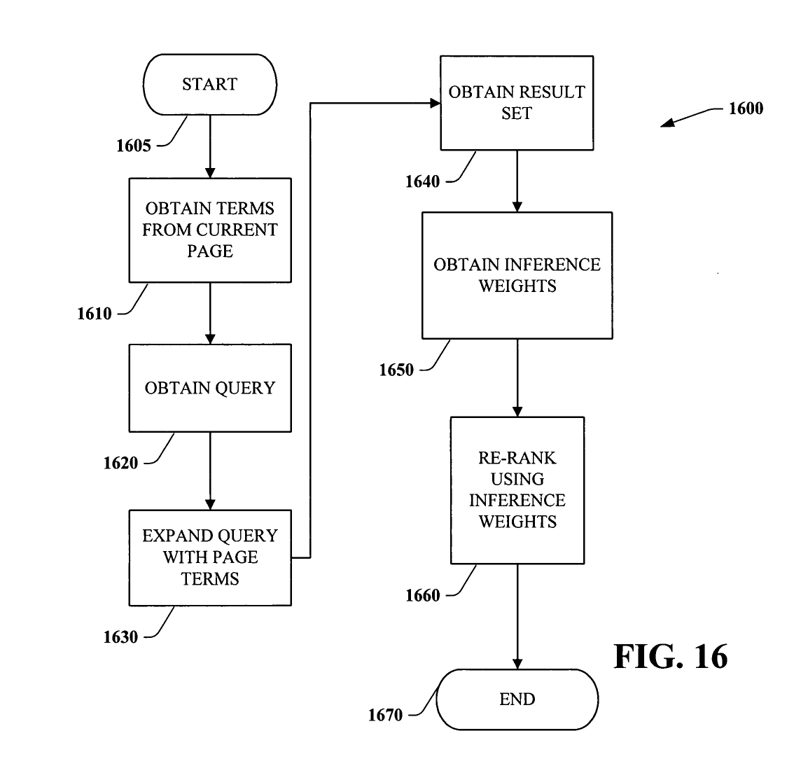

FIG. 16 is a flow diagram showing processing of a method 1600 that can be used in conjunction with components that are disclosed or described herein. The method 1600 can be used to rank Web pages or other suitable documents to be included in a set of search results based at least in part inference weights. Specifically, the inference weights can be used to rank pages that an inference engine determines are likely desired results for a user.

Processing of the method 1600 begins at START block 1605 and continues to process block 1610. At process block 1610, terms from the current Web page or document of are obtained. A search query is obtained at process block 1620. The search query is expanded using terms from the current Web page or other document at process block 1630. A set of results from search based upon the expanded query is obtained at process block 1640.

An inference weight is obtained for each item in the set of results by using a set of term associations combined with an inference engine to calculate a probability that a user desires to navigate to a page in the result set. At process block 1660 results in the set of results are re-ranked using the inference weights. Processing concludes at END block 1670.

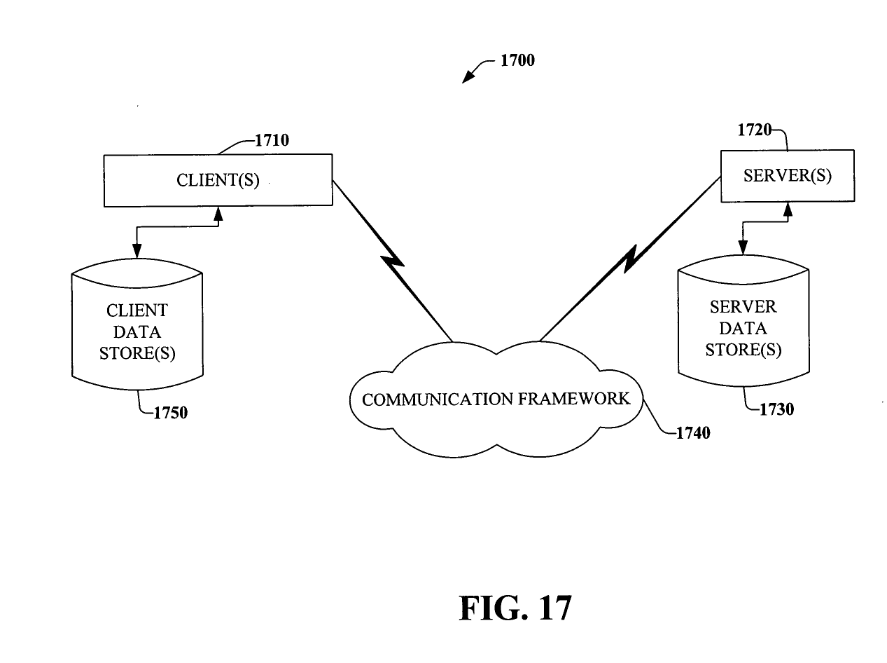

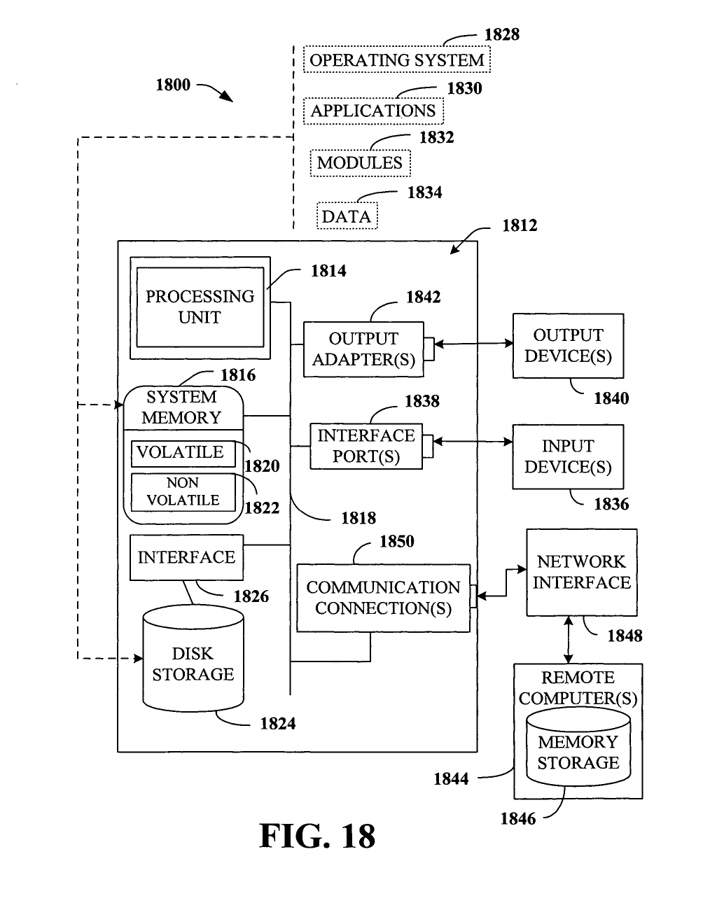

In order to provide additional context for implementation, FIGS. 17-18 and the following discussion is intended to provide a brief, general description of a suitable computing environment within which disclosed and described components and methods can be implemented. While various specific implementations have been described above in the general context of computer-executable instructions of a computer program that runs on a local computer and/or remote computer, those skilled in the art will recognize that other implementations are also possible either alone or in combination with other program modules. Generally, program modules include routines, programs, components, data structures, etc. that perform particular tasks and/or implement particular abstract data types.

Moreover, those skilled in the art will appreciate that the above-described components and methods may be practiced with other computer system configurations, including single-processor or multi-processor computer systems, minicomputers, mainframe computers, as well as personal computers, hand-held computing devices, microprocessor-based and/or programmable consumer electronics, and the like, each of which may operatively communicate with one or more associated devices. Certain illustrated aspects of the disclosed and described components and methods may also be practiced in distributed computing environments where certain tasks are performed by remote processing devices that are linked through a communications network or other data connection. However, some, if not all, of these aspects may be practiced on stand-alone computers. In a distributed computing environment, program modules may be located in local and/or remote memory storage devices.

FIG. 17 is a schematic block diagram of a sample-computing environment 1700 within which the disclosed and described components and methods can be used. The system 1700 includes one or more client(s) 1710. The client(s) 1710 can be hardware and/or software (for example, threads, processes, computing devices). The system 1700 also includes one or more server(s) 1720. The server(s) 1720 can be hardware and/or software (for example, threads, processes, computing devices). The server(s) 1720 can house threads or processes to perform transformations by employing the disclosed and described components or methods, for example. Specifically, one component that can be implemented on the server 1720 is a security server, such as the security server 240 of FIG. 2. Additionally, various other disclosed and discussed components can be implemented on the server 1720.

One possible means of communication between a client 1710 and a server 1720 can be in the form of a data packet adapted to be transmitted between two or more computer processes. The system 1700 includes a communication framework 1740 that can be employed to facilitate communications between the client(s) 1710 and the server(s) 1720. The client(s) 1710 are operably connected to one or more client data store(s) 1750 that can be employed to store information local to the client(s) 1710. Similarly, the server(s) 1720 are operably connected to one or more server data store(s) 1730 that can be employed to store information local to the server(s) 1740.

With reference to FIG. 18, an exemplary environment 1800 for implementing various components includes a computer 1812. The computer 1812 includes a processing unit 1814, a system memory 1816, and a system bus 1818. The system bus 1818 couples system components including, but not limited to, the system memory 1816 to the processing unit 1814. The processing unit 1814 can be any of various available processors. Dual microprocessors and other multiprocessor architectures also can be employed as the processing unit 1814.

The system bus 1818 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MCA), Extended ISA (EISA), Intelligent Drive Electronics (IDE), VESA Local Bus (VLB), Peripheral Component Interconnect (PCI), Peripheral Component Interconnect Express (PCI Express), ExpressCard, Card Bus, Universal Serial Bus (USB), Advanced Graphics Port (AGP), Personal Computer Memory Card International Association bus (PCMCIA), Firewire (IEEE 1394), Serial Advanced Technology Attachment (SATA), and Small Computer Systems Interface (SCSI).

The system memory 1816 includes volatile memory 1820 and nonvolatile memory 1822. The basic input/output system (BIOS), containing the basic routines to transfer information between elements within the computer 1812, such as during start-up, is stored in nonvolatile memory 1822. By way of illustration, and not limitation, nonvolatile memory 1822 can include read only memory (ROM), programmable ROM (PROM), electrically programmable ROM (EPROM), electrically erasable ROM (EEPROM), or flash memory. Volatile memory 1820 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 1812 also includes removable/non-removable, volatile/non-volatile computer storage media. For example, FIG. 18 illustrates a disk storage 1824. The disk storage 1824 includes, but is not limited to, devices like a magnetic disk drive, floppy disk drive, tape drive, Jaz drive, Zip drive, LS-100 drive, flash memory card, or memory stick. In addition, disk storage 1824 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1824 to the system bus 1818, a removable or non-removable interface is typically used such as interface 1826.

The various types of volatile and non-volatile memory or storage provided with the computer 1812 can be used to store components of various implementations of the data port signaling system disclosed and described herein. For example, with reference to FIG. 1, the ranking module 110 can be implemented as a software module in the non-volatile memory 1822. At runtime, information the ranking module 110 can be loaded into the volatile memory 1820 from where machine-interpretable code can be accessed by the processing unit 1814 and thereby placed into execution.

It is to be appreciated that FIG. 18 describes software that acts as an intermediary between users and the basic computer resources described in the suitable operating environment 1800. Such software includes an operating system 1828. The operating system 1828, which can be stored on the disk storage 1824, acts to control and allocate resources of the computer system 1812. System applications 1830 take advantage of the management of resources by operating system 1828 through program modules 1832 and program data 1834 stored either in system memory 1816 or on disk storage 1824. It is to be appreciated that the disclosed components and methods can be implemented with various operating systems or combinations of operating systems.

A user enters commands or information into the computer 1812 through input device(s) 1836. The input devices 1836 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1814 through the system bus 1818 via interface port(s) 1838. Interface port(s) 1838 include, for example, a serial port, a parallel port, a game port, and a universal serial bus (USB). Output device(s) 1840 use some of the same type of ports as input device(s) 1836. Thus, for example, a USB port may be used to provide input to computer 1812, and to output information from computer 1812 to an output device 1840. The interface ports 1838 specifically can include various data connection ports that can be used with components disclosed and described herein, among others.

Output adapter 1842 is provided to illustrate that there are some output devices 1840 like monitors, speakers, and printers, among other output devices 1840, which require special adapters. The output adapters 1842 include, by way of illustration and not limitation, video and sound cards that provide a means of connection between the output device 1840 and the system bus 1818. It should be noted that other devices and/or systems of devices provide both input and output capabilities such as remote computer(s) 1844.

Computer 1812 can operate in a networked environment using logical connections to one or more remote computers, such as remote computer(s) 1844. The remote computer(s) 1844 can be a personal computer, a server, a router, a network PC, a workstation, a microprocessor based appliance, a peer device or other common network node and the like, and typically includes many or all of the elements described relative to computer 1812. For purposes of brevity, only a memory storage device 1846 is illustrated with remote computer(s) 1844. Remote computer(s) 1844 is logically connected to computer 1812 through a network interface 1848 and then physically connected via communication connection 1850. Network interface 1848 encompasses wired and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1850 refers to the hardware/software employed to connect the network interface 1848 to the bus 1818. While communication connection 1850 is shown for illustrative clarity inside computer 1812, it can also be external to computer 1812. The hardware/software necessary for connection to the network interface 1848 includes, for exemplary purposes only, internal and external technologies such as, modems including regular telephone grade modems, cable modems and DSL modems, ISDN adapters, and Ethernet cards.

What has been described above includes illustrative examples of certain components and methods. It is, of course, not possible to describe every conceivable combination of components or methodologies, but one of ordinary skill in the art will recognize that many further combinations and permutations are possible. Accordingly, all such alterations, modifications, and variations are intended to fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (for example, a functional equivalent), even though not structurally equivalent to the disclosed structure, which performs the function in the herein illustrated examples. In this regard, it will also be recognized that the disclosed and described components and methods can include a system as well as a computer-readable medium having computer-executable instructions for performing the acts and/or events of the various disclosed and described methods.

In addition, while a particular feature may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

What is claimed is:

1. A system for searching for information, comprising:
a search module that obtains a set of results that is responsive to a query; and
a biasing module that ranks members of the set of results based at least in part upon a member of a set of information derived from a recently-viewed document.

2. The system of claim 1, wherein the set of information is a map that describes an arrangement of documents.

3. The system of claim 1, wherein the set of information is a probability distribution of terms that are included in the recently-viewed document.

4. The system of claim 1, wherein the set of information derived from the recently-viewed document is user demographic information.

5. The system of claim 4, wherein the demographic information is probabilistic.

6. The system of claim 1, further comprising an expansion module that uses the set of information to expand the query.

7. The system of claim 6, wherein the set of information is a set of search queries, wherein each one of the set of search queries returns an identifier for a document as a result that is ranked at least as highly as a preselected ranking.

8. The system of claim 1, further comprising a navigation module that creates the set of information, wherein the set of information includes a set of likely navigation paths from the recently-viewed document.

9. A method for information searching, comprising:
obtaining a result set wherein each member of the result set is responsive to a query; and
using information obtained from a result of a prior information search to assign a ranking to each member of the result set.

10. The method of claim 9, wherein using information obtained from a result of a prior information search includes using a topological map of a group of documents.

11. The method of claim 9, wherein using information obtained from a result of a prior information search includes using a probability distribution of terms included in a document.

12. The method of claim 9, wherein using information obtained from a result of a prior information search includes using demographic information of a user.

13. The method of claim 9, wherein using information obtained from a result of a prior information search includes using likely demographic information of a user.

14. The method of claim 9, further comprising expanding the query.

15. A system for information searching, comprising:
means for obtaining a result set wherein each member of the result set is responsive to a query; and
means for using information obtained from a result of a prior information search to assign a ranking to each member of the result set.

16. The system of claim 15, wherein the means for using information obtained from a result of a prior information search includes means for using a topological map of a group of documents.

17. The system of claim 15, wherein the means for using information obtained from a result of a prior information search includes means for using a probability distribution of terms included in a document.

18. The system of claim 15, wherein the means for using information obtained from a result of a prior information search includes means for using demographic information of a user.

19. The system of claim 15, wherein the means for using information obtained from a result of a prior information search includes means for using likely demographic information of a user.

20. The system of claim 15, wherein the means for obtaining a result set includes means for expanding the query.
